(19) United States
(12) Patent Application Publication
(10) Pub. No.: US 2015/0081557 A1
(43) Pub. Date: Mar. 19, 2015

(54) METHOD OF PROCESSING PAYMENT TRANSACTIONS

(71) Applicants: Craig Patrick Kinfoil, Glanmire (IE); Charles Loots, Sandton (ZA); Antoine Aurélien Duarte, Edenburg (ZA)

(72) Inventors: Craig Patrick Kinfoil, Glanmire (IE); Charles Loots, Sandton (ZA); Antoine Aurélien Duarte, Edenburg (ZA)

(21) Appl. No.: 14/551,118

(22) Filed: Nov. 24, 2014

Related U.S. Application Data
(63) Continuation-in-part of application No. 12/747,187, filed on Sep. 14, 2010, now abandoned.

(51) Int. Cl. G06Q 20/40

(52) U.S. Cl. CPC G06Q 20/40
USPC 705/44

(57) ABSTRACT

A method of processing a transaction associated with a transaction instrument includes providing a server, receiving an update message at the server which includes data to assign a transaction use case associated with the transaction instrument, the server identifying a device user, a device or both and the associated transaction instrument, the server updating the stored transaction use case state associated with the transaction instrument, receiving a transaction request against the transaction instrument from a transaction requestor, the server classifying the transaction use case to determine a classified transaction use case associated with respect to the transaction instrument, the server determining whether the stored state of the classified transaction use case is an allowed or disallowed state, and transmitting a message to the transaction management system containing data confirming the state of the classified transaction use case, providing a general response of allowed or disallowed, or both.

### CROSS-REFERENCE TO RELATED APPLICATION

The present application claims the benefit under 35 U.S.C. §120 of U.S. patent application Ser. No. 12/747,187 to the inventor, filed Jun. 10, 2010 and pending, which in turn was a 371 entry of Int'l. Appl. Ser. No. PCT/IB2007/055015, filed Dec. 11, 2007. The entire contents of these applications are hereby incorporated by reference herein.

### BACKGROUND

1. Field.

The example embodiment in general is directed to a method of processing payment transactions, more particularly to secure payments, reduce fraudulent transactions and prevent the erroneous rejection of non-fraudulent transactions.

2. Related Art.

Payment transactions have always been prone to fraud, to a lesser or greater extent depending on the means and method of payment elected. The likes of forged bank notes, fraudulent cheques and forged negotiable instruments have historically been used to obtain unauthorized or unlawful payments from institutions that negotiate transactions using such payment instruments.

A cornerstone of the problem is that an entity or person, the account holder, places trust in another entity, a bank, to make payments on its behalf. The account holder places funds into an account with the bank or receives a credit line on such account, and instructs the bank to release payment to any party once certain conditions have been met.

These release conditions or payment conditions include that the bank has to positively confirm that the requested transaction, which a third party typically presents to the bank, indeed originates from the account holder. In making payment on a cheque the bank, for example, needs to confirm that the cheque was signed by the account holder, and this is done by comparing the signature on the cheque to a specimen signature on file at the bank.

In any fast moving economy, such labor-intensive confirmation processes place a significant burden on the efficiency of processing transactions. For this reason, amongst others, payment cards and electronic fund transfer (EFT) payments are very popular and practically speaking the norm.

A well-known problem with card payments, whether debit, credit or other payment cards, is that cards can be easily cloned and presented for payment. This problem is exacerbated with the international use of payment cards. A card may legitimately be presented for payment in one country today and in another the next day. Internet purchases also means that physical travel to another country is not required to perform a purchase there. Many, if not most, Internet merchants include payment facilities that require a card number, expiration date and card security code to be submitted for payment. The merchant supplies this card information to his payment processor for authorization without necessarily having any relationship with the bank at which the account is held since all communications take place via intermediaries. The bank authorizes such a payment transaction with minimal information at its disposal.

Payment cards mostly have associated security features or are used in systems that include the use of secret information, such as a card verification value or PIN, which is supposed to be known only to the account holder and can be verified to be correct by the bank. This information typically acts as a means to authenticate the account holder. If a payment request is presented that includes this information, the transaction is processed. Unfortunately there is still no clear guarantee that the legitimate account holder provided this information, as the information can be acquired and abused by third party, through various means.

Some banks utilize after-the-fact notification services to inform account holders of transactions that have been concluded. The systems used by some banks are under normal conditions very fast in notifying an account holder of a transaction, and the theory is that if an unauthorized transaction is presented for payment, the account holder can contact the bank. Since this happens after the transaction has already been processed, the bank has already approved the transaction and the merchant has likely already been supplied the goods or provided the service. The transaction can be disputed, but this does not always result in the recovery of funds. The direct and indirect cost of administering such disputes is also a significant expense.

The effectiveness of such systems is hampered by the fact that the notifications are typically sent by text message to mobile phones or to an email account. Of these two types, email is generally the slowest and in reality most people will not receive such a notification until a significant amount of time has passed. Text messages to mobile phones are a much faster means of notification, but they are not perfect, nor instantaneous or guaranteed. Some banks will only notify an account holder of a transaction if it exceeds a threshold value. This is to avoid an account holder from being notified of small charges put through on his account, for example interest and bank charges. Some banks allow the account holder to set such limits. Also, if the mobile phone is not within reach of a mobile phone communication tower then receipt of the message is delayed until it moves into a mobile communications coverage area again.

An account holder that is on holiday in a foreign country may in an effort to reduce roaming charges have his mobile phone turned off, at least most of the time on such holiday. A fraudulent transaction presented on the account of the account holder at such time will normally go by unnoticed until such time that the account holder receives the text message. Again, by then the bank will already have approved the transaction.

Another aspect that impacts negatively on the effectiveness of using text messages to notify an account holder is that many people switch their mobile phones off at night, or they use the mute function or privacy settings on such phones to keep notifications from disturbing them. Fraud syndicates structure their operations to take advantage of this by processing transactions during this time, either online or in foreign territories located in different time zones.

The relevance of this is that one of the most common ways wherein payment cards are compromised is so-called card skimming A third party with access to a payment card passes it through a card reader, a so-called “skimming device”, which stores the card data on storage means associated with the skimming device. The data is then later used in fraudulent online and physical transactions.

This skimming operation is very often performed in restaurants and other entertainment venues where waiters are often participants in these operations. Such a waiter will typically have a skimming device hidden in the pocket of an apron or underneath the apron. A person skilled in this technique requires very little time—in the order of mere seconds—to pass the card through the skimming device, and will do so unnoticed.

At the end of his shift the waiter will connect the skimming device to a computer and the card details are then supplied to an accomplice, very often in another jurisdiction, which makes prosecution by law enforcement difficult. The accomplice will test the skimmed card details by making small test purchases using the card details. The waiter is paid an agreed amount for each card that successfully passes the test purchase. The amount used in this test purchase is typically very small and generally falls below the threshold set by some banks for notifying an account holder of a transaction. The account holder will at this time still not know that his account had been compromised.

The accomplice will then encode blank cards using the skimmed card details. Often the help of disreputable merchants are then enlisted to make fake fraudulent purchases, or purchase goods that can be easily converted into cash or to simply pass purchases through their payment terminals. In many cases, the cards are swiped for payment to the daily limit of each card. The cards will again be swiped the next day to the same limit, and so on until the card has been cancelled by the issuing bank. By then, substantial amounts will have been requested in payment using the normal banking channels.

Once the card has been cancelled, it is of no use to the thieves and will be discarded.

Since many of these syndicates operate in countries foreign to the one where the account holder resides, the chances are that at least the first fraudulent payment request on the card will be made whilst the account holder is still asleep at home. If his card was skimmed whilst he was having lunch or dinner, the skimmed card details will reach the accomplice of the waiter at a time when it is nighttime in the home country of the account holder. This will then be the time that in many instances the account holder has his mobile phone switched off or a “Do Not Disturb” feature prevents the notification from reaching the account holder. Some people also just simply do not wake up when a text message is received during the night. Also, many banks do not have 24-hour payment notification services or fraud monitoring departments and will only realize the following day that a foreign payment request was processed during the night. The thieves know that time is of the essence and will make payment requests on the card as soon as possible and by the time the account holder wakes up, thieves will have depleted the funds in the account.

There have been attempts to improve on this by making use of systems that will prompt the client to authenticate the transaction during the authorization process at the bank. In principle this is a good idea. The reality is however that it leads to more frustration for the merchant, account holder and other shoppers. Such systems utilize text messages to notify the account holder that a payment request on his account has been made and the account holder has to reply to the message as confirmation that it is legitimate before the payment is released.

The problem with this is that most merchant's electronic payment terminals have a very short time-out period, typically in the region of no more than 30 seconds. This means that unless the payment terminal receives confirmation from the bank within the time-out period, it reports that the transaction has not been approved. It is very difficult for most people to open a text message and respond to it in a matter of seconds. It also happens that during peak shopping hours, such as over peak shopping periods like Christmas, shopping malls are very congested. This is accompanied by high volumes of data traffic and in particular text messages, which increase delays in delivery. It is not uncommon for text messages to be delayed in such circumstances leading to a situation where a valid payment is repeatedly presented for payment and the message to authorize the transaction is received too late to transmit a confirmatory message in time.

The account holder will thus become unable to use such a payment card at such a time, and will instead rely on an alternative card that does not require the text message confirmation. If the account holder uses that alternative card at a venue where a person skims his card, the account holder is then back in the situation where his card is compromised and transacted upon without the account holder's knowledge.

Reliance on text messaging for inline and reactive approval of pending payment transactions have for this reason not met with approval from banks and their customers.

An improved payment card that is promoted in the payment card industry is the so-called chip card or smart card. This relies on an embedded chip on the card that stores data that is readable by a chip reader integrated with a payment terminal. The distinguishing feature of the chip card is that it requires a PIN to initiate the transaction process.

These cards have been promoted as the solution to card skimming. Unfortunately it leads users into a false sense of security and they end up becoming less aware of what happens with their card when it is presented for payment.

Most chip cards still include a magnetic strip since internationally not all merchants have converted their payment terminals to the newer types that support chip cards. Such a card can thus still be used on a payment terminal that only supports magnetic strips. The syndicates operating the card skimming networks are well aware of this. The data from the magnetic strip of a skimmed chip card is written or encoded onto another card bearing a magnetic stripe and used at a payment terminal that reads the magnetic stripe.

Additionally to the magnetic strip's fallback, chip cards have not provided any additional security for online/internet (Card not Present) transactions. For the majority and largest of online retailers only a card's printed and embossed information is required to complete a transaction. Some chip card issuers support the generation of an authentication code using the chip card itself and an additional device. This code may then be used in an e-commerce environment, but it requires the merchant and other intermediaries to be able to accept entry of and transmit this value. This need for modification to existing systems means that market penetration is poor and the approach less effective than desired.

In a further effort to reduce the aforementioned risks, banks currently have two primary approaches:
(1) Institute limits on payment value, payment location and payment volume; and/or
(2) Implement predictive systems that use a variety of patterns, counters and characteristics with regards to a transaction to determine if a transaction should be declined based on the probability of it being fraudulent.
   These approaches have their varying degree of effectiveness, but often still fail to recognize fraudulent transactions, while at the same time creating inconvenience, frustration and embarrassment for card holders and ultimately cause losses with regards to both fraud and lost legitimate transactions.

The primary failure of the current primary approaches to prevent payment card fraud is that they do not include the account holder in the process of making decisions of what, where and when transactions should be blocked or allowed. At the end of the day—the best person to answer and provide input into what transactions should be approved is the account holder or authorized user of a payment card himself.

With the ubiquitous nature of today's mobile devices bringing telecommunication and connectivity to almost every inch of the planet it has now become feasible to allow customers to control their cards and protect their money by simply using a mobile device.

In summary, no prior art system has managed to effectively curb payment card fraud without causing substantial additional inconveniences and hence lost spending themselves. Even with today's many inventions that attempt to combat the payment card fraud problem, massive amounts of money are still stolen from bank accounts every day from fraudulent card transactions due to the fact that they have never made the account holder centric to the process.

### SUMMARY

An example embodiment of the present invention is directed to a method of processing a transaction associated with a transaction instrument including providing a server with an associated processor and associated storage, a transaction use case interface configured to allow communication between the server and a device associated to a transaction instrument with at least one associated transaction use case, a transaction request interface configured to allow communication between the server and a transaction requestor via a transaction use case, and communication means between the server and a transaction management system, and storing on the server a channel state for each transaction use case associated with the transaction instrument, receiving, at the server via the transaction use case interface, an update message from the device, the update message including data configured to be interpreted by the server to assign a transaction use case associated with the transaction instrument with either an allowed or a disallowed state, the server identifying, with or without authentication, either the device user or the device or both and the associated transaction instrument, the server updating the stored transaction use case state associated with the transaction instrument on the server, receiving, at the server via the transaction request interface, a transaction request against the transaction instrument from a transaction requestor, the server classifying the transaction use case used in the transaction request to determine a classified transaction use case associated with respect to the transaction instrument, by evaluating the fields in the transaction request, the server retrieving the stored state of the classified transaction use case, the server determining whether the stored state of the classified transaction use case is in the allowed or disallowed state, and the server transmitting a message to the transaction management system containing data confirming either the state of the classified transaction use case or providing a general response of allowed or disallowed or both.

There is further provided for the method to include the server transmitting a decline message via the transaction request interface to the transaction requestor including data configured to be interpreted by the transaction requestor confirming that the stored state of the classified transaction use case is set as disallowed, and further preferably the server transmitting an approval message via the transaction request interface to the transaction requestor including data configured to be interpreted by the transaction requestor confirming that the stored state of the classified transaction use case is set as allowed.

There is further provided for the method to include the server transmitting a message via the transaction request interface to the transaction requestor including data configured to be interpreted by the transaction requestor indicating that the transaction request is approved or declined, based on whether the stored state of the classified transaction use case is set as allowed or disallowed.

There is further provided for the server to classify transaction use cases associated with a transaction request associated with a transaction instrument by evaluating a series of transaction fields extracted from the transaction request message, applying optional data sanitization, transformation and logic processing to a combination of such values within thresholds defined by configurable parameters associated to the server or the transaction instrument or the device or the device user or data sourced from an external system such as but not limited to a fraud scoring system or a geo-location system.

There is further provided for the server to perform additional checks before or after classifying transaction use cases by evaluating transaction fields extracted from the transaction request message within thresholds defined by configurable parameters associated to the server or the transaction instrument or the device or the device user or data sourced from an external system, and optionally for the outcome of these checks to result in the transaction request being approved or declined, regardless of the allowed or disallowed state of the classified transaction use case.

There is further provided for the method to include the server receiving via the transaction use case interface from the device a query message including data configured to be interpreted by the server to determine confirming a stored transaction use case state associated with the transaction instrument and to transmit to the device a message containing data configured to be interpreted by the device confirming such stored transaction use case state.

There is further provided for the state of a transaction use case stored in the server to be any one of allowed, limited by time, number for transactions, location, currency, value, merchant, type of merchant or other attribute, and preferably for the update message or the query message to relate to any such state.

There is further provided for the server to be configured to automatically change a transaction use case state to allowed or disallowed upon the occurrence of any one or more of a number of events, including but not limited to, a transaction occurrence, the expiry of predeterminable period of time, or after a predeterminable period of inactivity.

There is further provided for the server to be configured to automatically modify configurable parameters associated with a transaction instrument upon the occurrence of any one or more of a number of events including, but not limited to, a transaction occurrence, the expiry of predeterminable period of time, or after a predeterminable period of inactivity.

There is further provided for the method to include the server transmitting via the transaction request interface to a transaction management system associated with the transaction instrument an approval message in the event that the stored state of the classified transaction use case is set as allowed.

There is still further provided for the server to store data of a plurality of transaction instruments, and further additionally to store data of multiple transaction instruments from one or more transaction instrument issuers in association with a single device.

There is still further provided for the server to store data associating more than one device with a single transaction instrument.

There is still further provided for the method to include the server managing a subset of transaction use cases in respect of which each device or device user may alter the transaction use case states as associated to a transaction instrument.

There is still further provided for the method to include the server managing an allowed range of values with which each device or device user may alter the configurable parameters as associated to a transaction instrument.

There is further provided for the method to include the server transmitting to an associated device messages stating the allowed or disallowed outcome of transactions.

There is further provided for the method to include the server transmitting to an associated device messages providing reasons for transactions being disallowed.

There is further provided for the method to include transmitting to an associated device messages providing a solution of submitting a transaction again, such as which transaction use case states to allow, if a transaction instrument is used by a transaction requestor without modifying the state of the transaction use case relating to the transaction instrument to allowing transactions or allowing transactions within configurable parameters.

There is further provided for the method to include the server transmitting via the transaction use case interface to an associated device a message including data configured to be interpreted by the associated device requesting confirmation of a transaction, and for the server to receive via the transaction use case interface from such associated device a message including data configured to be interpreted by the server confirming or denying the request for such transaction.

There is further provided for the method to include the server transmitting via the transaction use case interface to an associated device a message including data configured to be interpreted by the associated device requesting authentication of a transaction, and for the server to receive via the transaction use case interface from such associated device a message including data configured to be interpreted by the server authenticating such transaction.

There is still further provided for the method to include the server being configured to manage an allowed range of values with which each device or device user may alter the configurable parameters as associated to a transaction instrument.

There is still further provided for a server to be configured to manage a number of devices to which messages will be transmitted based on the allowed/disallowed outcome of a transaction using an associated transaction instrument.

There is still further provided for a server to be configured to manage a subset of messages that will be transmitted to each device.

There is further provided for the method to include the server including an associated directory server containing stored data of at least one transaction instrument issuer, and associated issuer identification number (IIN) data containing details of supported transaction instruments in relation to transaction instrument issuers.

There is further provided for the method to include the directory server receiving from a device via the transaction use case interface a directory lookup request message requesting retrieval of one or more server network addresses for the transaction instrument issuer of a specified transaction instrument, if the transaction instrument is identified on the directory server transmitting to the device a positive response message included one or more server addresses of the transaction instrument issuer associated with the transaction instrument; and still further preferably if a transaction instrument is not identified on the directory server transmitting to the device a rejection message confirming that directory data for the transaction instrument in its lookup request message could not be located.

There is further provided for the method to include the server receiving from a device via the transaction use case interface an enrolment request message including data configured to be interpreted by the server requesting enrolment of the device with an associated transaction instrument on the server, the server comparing the received data relating to the transaction instrument to the data stored on the server, if the transaction instrument is identified on the server associated to the device or device user, transmitting to the device a positive enrolment response message including data configured to be interpreted by the device such as the description and design associated with the transaction instrument; and still further preferably if a transaction instrument is not so identified transmitting to the device a rejection message including data configured to be interpreted by the device confirming that the transaction enrolment request failed.

There is further provided for the device to store information about the transaction instrument or network server addresses of the transaction instrument issuer.

There is further provided for the method to include the server including an associated membership service containing data of device users, optionally associated devices and optionally associated transaction instruments.

There is further provided for the server to receive a message from a device requesting a listing of devices and associated transaction instruments that can potentially be enrolled or are already enrolled for a device or device user and the server responding with a message including the requested listings of devices and associated transaction instruments.

The example embodiment further provides for the provision of a transaction instrument issuer interface which is configured to provide a transaction instrument issuer with the ability to define which transaction use cases are available for channel state modification in respect of a supported transaction instrument, and to query and modify the state of respective transaction use cases.

There is further provided for the server to transmit a message to the transaction requestor directly, or out of band from the transaction request, informing whether a transaction is allowed or disallowed.

There is further provided for authentication of the device or device user by the server to comprise the server receiving from the device a message including data configured to be interpreted by the server that provides the server with a device identifier, token or other credentials associated with the device or a transaction instrument associated with the device as stored on the server.

There is further provided for the method to include the provision of input to a risk assessment algorithm utilizing the transaction use case state stored on the server.

There is further provided for the method to include leveraging data from a central knowledge base to assist in transaction or transaction use case classification based on configurable parameters.

There is further provided for the server receiving from a device via the transaction use case interface a message including data configured to be interpreted by the server requesting the configurable parameters associated with a transaction instrument, retrieving the parameters from the server, sending a response message to the device including data configured to be interpreted by the device containing the requested configurable parameters.

There is further provided for the server receiving from a device via the transaction use case interface a message including data configured to be interpreted by the server requesting the modification of configurable parameters associated with a transaction instrument, updating the parameters on the server, sending a response message to the device including data configured to be interpreted by the device confirming the update.

There is further provided for a computerized system implementing the method as defined above.

There is further provided for the transaction use case interface to be accessible by means of a mobile phone using any one or more of communication channels including without limitation:

WAP (Wireless Application Protocol);

USSD (Unstructured Supplementary Service Data);

SMS/Text (Short Message Service);

MMS (Multimedia Message Service);

STK (SIM Application Toolkit);

WIG (Wireless Internet Gateway); and

Smartphone application

There is further provided for the transaction use case interface to be accessible by means of a computing device via a web browser accessing a secure website such as Internet banking, alternatively using an IVR system.

There is further provided for the method to include authentication of a device user or assignee of a transaction instrument using authentication schemes including without limitation:

PIN;

Password;

Certificates;

Biometrics;

Tokens; and

Challenges

There is further provided for the system to comprise a switching mechanism interposed between multiple transaction request interfaces and transaction management system interfaces.

These and other features of the example embodiments of the present invention are described in more detail below.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a block diagram showing the high level interactions and context of various system components.

FIG. 2 is an activity diagram showing modification of the transaction use case state by the device user sending a message to the server, in accordance with one embodiment.

FIG. 3 is an activity diagram showing transaction authorization processing based on an existing transaction use case state, in accordance with one embodiment.

FIG. 4 is an activity diagram showing transaction authorization processing where the device user is requested to set the correct transaction use case state, in accordance with one embodiment.

FIG. 5 is an activity diagram showing different branching based on the device user's response to a message received from the server, in accordance with one embodiment.

FIG. 6 shows sample screens of a smartphone application that provide the device user with a graphic means to change transaction use case state, in accordance with one embodiment.

### DETAILED DESCRIPTION

It is the objective of this example embodiment to provide a system and method that at least partly overcomes the abovementioned problems identified in the Background section of this application.

Example embodiments of the present invention are described below. In an effort to keep the description concise, not all features of an actual implementation are described. Given this disclosure, persons of average skill will be able to implement a full system delivering on the goals of this invention.

The present disclosure is directed to various techniques for empowering the user of an electronic device to proactively, reactively or interactively control a transaction instrument's ability to transact.

As used herein, the following terms and phrases will have the following meanings: “device” includes any electronic device such as a mobile communications device capable of data transmission, input and output; “transaction instrument” includes any instrument such as but not limited to an account number, a credit card, debit card, store card, whether physical or virtual, which contains a uniquely identifiable number used to initiate a transaction request; “transaction instrument issuer” includes but not limited to banks, merchants, associations and related service providers such as processors; “issuer identification number” (IIN) includes any identifying numbers of a transaction instruments' uniquely identifiable number, or a short code attached thereto, that is used to determine the transaction instrument issuer; “transaction management system” includes a system that contains a server with a processor that manages or processes transactions requests originating from a transaction requestor; “transaction use case” means a classification used to categorize the usage scenario or environment which a transaction was initiated from, such as but not limited to, international transactions, in-store purchases, teller withdrawals, internet transactions, travel, mail and telephone transactions, chip cards used in fallback mode, entertainment, Internet banking, Internet banking payments, mobile payments, high value transactions, high risk transactions or transactions above or below user selected limits. Transaction use cases are computed by extracting fields from the transaction request message, received from the transaction requestor and applying optional data sanitization and logic processing to a combination of such values within thresholds defined by configurable parameters associated to the server or the transaction instrument or the device or the device user or data sourced from an external system such as but not limited to a fraud scoring system or a geo-location system; “transaction use case interface” means the interface through which a device is able to query, and possibly alter transaction use case state; “transaction use case user interface” means the man-machine-interface that allows the device user to query, and possibly alter transaction use case state; “transaction requestor” means a device, system or other entity from where transaction requests originate. For example this includes, without limitation, a teller, a merchant device, an issuer system, a financial institution, a retailer or a web site; “transaction request interface” means the interface where the transaction request is received; “transaction instrument assignee” includes any entity that a transaction instrument has been assigned to; “device user” includes any party using the device being a transaction instrument assignee, an account owner or an account supervisor; “server” includes any singular server or grouping of physical or virtualized servers containing communication, processing and/or storage capability; or form functionality of the transaction management system or another system. The server storage capability includes the ability to store data and system state in both a volatile manner such as in memory or in a persistent manner such as on disk using for example database technologies.

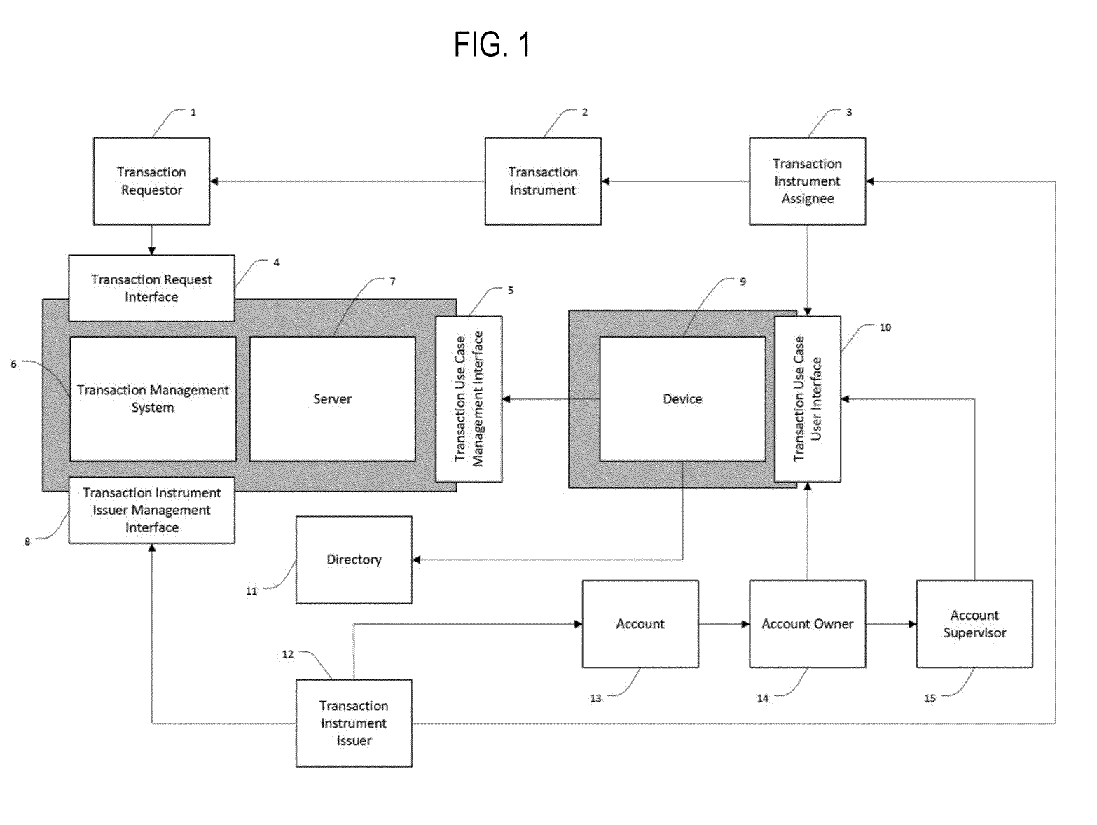

FIG. 1 provides a block diagram showing the high level interactions and context of various system components relating to the invention. In particular, it provides a method of processing a transaction associated with a transaction instrument including: providing a server (7) with an associated processor and associated storage, a transaction use case interface (5) configured to allow communication between the server (7) and a device (9) associated to a transaction instrument (2) with at least one associated transaction use case, a transaction request interface (4) configured to allow communication between the server (7) and a transaction requestor (1) via a transaction use case, and communication means between the server (7) and a transaction management system (6); and storing on the server (7) a channel state for each transaction use case associated with the transaction instrument (2); receiving at the server (7) via the transaction use case interface (5) an update message from the device (9), the update message including data configured to be interpreted by the server (7) to assign a transaction use case associated with the transaction instrument (2) with either an allowed or a disallowed state; the server (7) identifying, with or without authentication, either the device user or the device or both and the associated transaction instrument (2); the server (7) updating the stored transaction use case state associated with the transaction instrument (2) on the server (7); receiving at the server (7) via the transaction request interface (4) a transaction request against the transaction instrument (2) from a transaction requestor (1); the server (7) classifying the transaction use case used in the transaction request to determine a classified transaction use case associated with respect to the transaction instrument (2), by evaluating the fields in the transaction request; the server (7) retrieving the stored state of the classified transaction use case; the server (7) determining whether the stored state of the classified transaction use case is in the allowed or disallowed state; and the server (7) transmitting a message to the transaction management system (6) containing data confirming either the state of the classified transaction use case or providing a general response of allowed or disallowed or both.

The various techniques for empowering the user of an electronic device to proactively, reactively or interactively control a transaction instrument's ability to transact is, in one embodiment of the example embodiment, achieved by sending messages bi-directionally across a communications network, between the device (9) and the server (7) connected to a transaction processing environment (6). The server (7) may send messages to the device (9) indicating approved, declined or blocked transactions and instructions on how to overcome blocked transactions or request the user to allow specific transactions. The server (7) in turn engages in the transaction processing lifecycle and is able to affect the outcome of a transaction in a positive or negative manner.

Messages may be sent either during or outside of the lifecycle of a transaction and the device (9) user may optionally respond by allowing, disallowing or indicating that a transaction appears fraudulent. By participating in the control of all or certain transactions, the device user can reduce exposure to fraud and ensure that the approval rate of legitimate transactions is increased. Higher approval rates should be achieved by providing fraud prevention systems with additional assurance of the authenticity of a transaction.

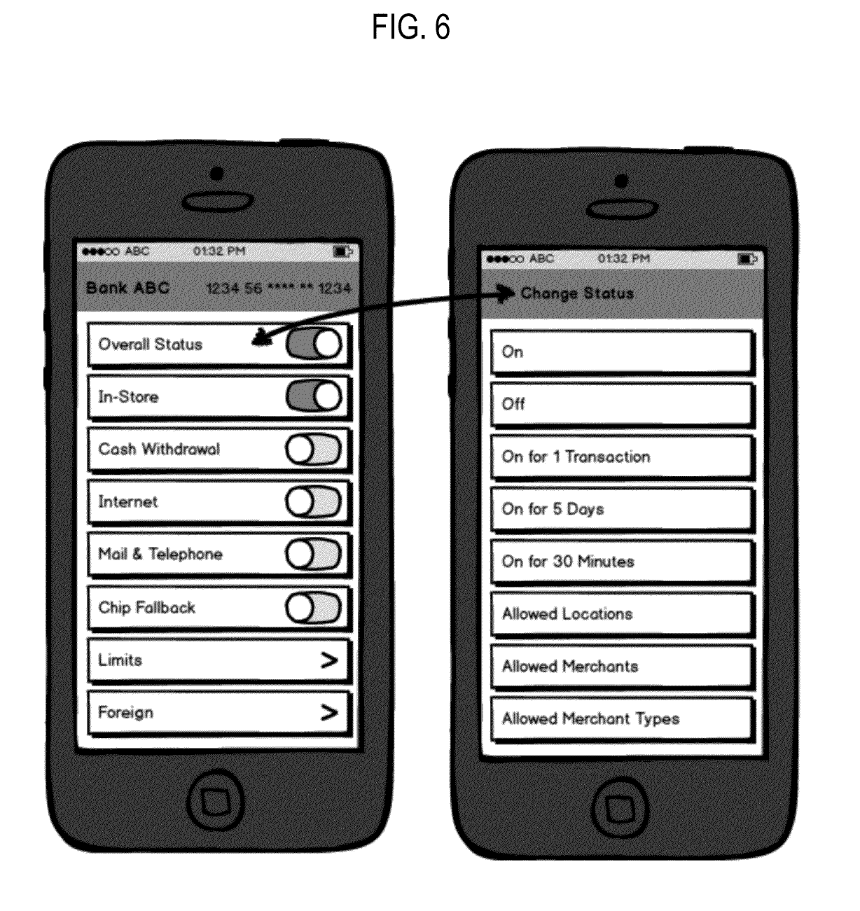

The example embodiment has been designed to be intuitive to persons without any technical understanding of transactional attributes, by grouping transactions into simple, easy to understand categories defined as “transaction use cases”. An example of this approach is illustrated in FIG. 6. The example embodiment aims to empower transaction instrument assignees, account owners or account supervisors, to understand, manage, secure accounts, and to alleviate the anxiety caused by not being able to complete transactions when funds are available.

As an example, the holder of a payment debit card (transaction instrument assignee) could disable the debit card (transaction instrument) from being able to withdraw cash (transaction use case). This would prevent all cash withdrawal transactions using the card from being approved, inclusive of those from originating from various sources (transaction requestor) such as automated teller/banking machine (ATM/ABM) or cashback at point-of-sale.

The cardholder may also disable fall-back transactions on a chip card (another transaction use case). This would prevent approval of transactions where the magnetic strip of the card was being used instead of the chip, reducing exposure to a common counterfeiting strategy, as described in the background to the example embodiment. Should the cardholder legitimately need to make use of this mode of operation, such as when the chip card or terminal is damaged, the transaction use case can be temporarily enabled.

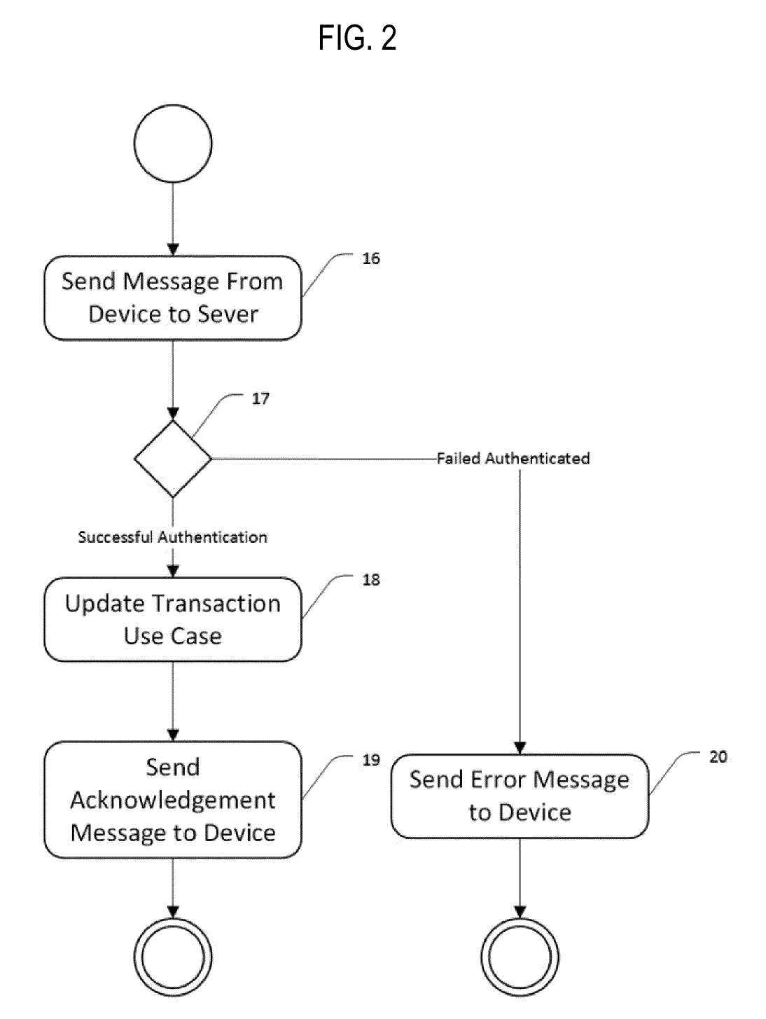

The communication between the device and the server requires for the device (9) or device user or both to be authenticated by the server (7). This is shown in more detail in FIG. 2, wherein a client transmits a message (16) from his device to the server to update a transaction use case state (18) on the server. Upon receipt of the message (16), authentication is conducted in respect of the message (16). If it is authenticated the transaction use case state is updated (18) accordingly and an acknowledgement message (19) is sent to the device. If the authentication fails an error message is sent to the device (20), and the transaction use case state is left unchanged.

The choice of device is not limited to a specific type of device, and may include a so-called smartphone and an older type legacy phone. For example, as shown in FIG. 6, a cardholder could use a mobile smartphone with a graphical user interface (transaction use case user interface) to send a message to the server while authenticating the device as well as the user. In another embodiment the cardholder could use a legacy mobile feature phone with a text based user interface (transaction use case user interface) to send a message to the server (7) while authenticating only the originating device or the device user. The text based user interface may take the form of SMS/Text messages or USSD calls.

The messages will be transmitted and received using the communications interfaces and communications network available to the device (9) and offering direct or intermediated connectivity between the device (9) and the server (7) across this communications network.

The authentication described above with reference to FIG. 2 would apply to both the smartphone and the legacy phone, though in a manner compatible with each of the respective technologies.

The server (7) stores and maintains the cardholder selected state associated with each transaction use case against each transaction instrument (2), such as a card. By providing a use case management interface (5) to the transaction use case user interface (10), the cardholder is able to query or modify the state for each transaction use case. By providing a transaction instrument issuer use case management interface (8), the transaction instrument issuer (12) is able to perform both administrative data maintenance of card and cardholder data and query or modify the state for each transaction use case. The transaction instrument issuer (12) is able to make changes on behalf of the device user using the transaction instrument issuer management interface (8), should they not be in a position to do so, such as in the case of device failure. In this case the actions may be performed by, for example, issuer call centre agents or branch staff.

The server (7) also categorizes incoming transaction requests to determine the transaction use case(s) that applies to the transaction. The categorization involves the analysis of various financial messaging attribute values and identifying certain defined combinations or patterns.

The stored state of each of the transaction use cases of the card (2) to which the transaction request applies is checked, and this determines whether the transaction is eligible to be approved (provided that other compulsory checks are also successful).

In one embodiment, should the stored transaction use case state not allow for the transaction request to be approved, the transaction will be declined (28) and the device user will be notified (29) about the decline by a message sent from the server to the device user. In another, the server will send a message (38) to the device user in an attempt to solicit the user to allow the transaction use case (39-41) before continuing with checks. It must be noted that there are practical timing limitations to the latter approach. Should the device user not respond in a preconfigured timespan, a default action will be assumed (42) to avoid the timeout conditions in the overall transaction flow. With the user actively allowing a transaction use case, optionally for only the specific transaction, the regular authorization checks or fraud prevention system checks may now allow for the transaction request to be approved.In one embodiment, should the regular authorization checks (25) or fraud prevention system checks (24) not allow for the transaction request to be approved, the transaction will be declined (28) and the device user will be notified about decline by a message sent from the server to the device (29).

The device user will have the option to allow a transaction use case (50) using the transaction use case user interface (10) on the device (9) to send a message to the server (7). In this event the transaction use case state is updated (51) to an allowed state. In another embodiment the transaction use case allowed state will only apply to the specific, current transaction.

The device user may also have the option to disallow (53) a transaction use case using the transaction use case user interface (10) on the device (9) to send a message to the server (7). In this event the transaction use case state is either updated to a disallowed state or maintained in the existing disallowed state. In another embodiment the device user will also have the option to report the transaction attempt as unsolicited or suspicious (48), which will result in the server sending a notification to a fraud prevention platform (49) including the information associated with this action.

The message sent by the server (7) to the device (9) may contain any of the following informational data elements using language appropriate to the device user: identifying the affected card, the transaction outcome (e.g. approved, declined, blocked, in need of approval), currency, amount and card acceptor name. Additionally, in the case where a transaction request has been declined or not yet approved, the message may contain a simple prompt or instructions on how to enable the transaction use case. It may also contain a simple prompt or what actions to follow if the device user believes the transaction to be fraudulent.

One person, who happens to be both instrument assignee and account owner (14), could use the device (9). The device user could also be the transaction instrument assignee (3), account owner (14), account supervisor (15) or a combination of one or multiple persons performing each of these roles.

An embodiment optionally allows for the transaction use case state of a single transaction instrument to be controlled from multiple authorized devices, as well as for messages to be sent from the server to multiple authorized devices associated to a single transaction instrument. The server (7) allows for control, or overriding supervisory control from the various participants. It also allows for the various participants to interact either collectively or individually with the server (7) using the bi-directional messaging facilities.

The device user may additionally, as an alternate or backup approach, use other methods to change the state of the transaction use case. This may include visiting a branch or calling into a call center for administrative assistance, or using a self-service platform such as Internet banking, a self-service terminal or an IVR. These platforms, operated by the transaction instrument issuer (12) or their service providers, modify the transaction use case state on the server (7) using the transaction instrument issuer management interface (8).

In another embodiment a device user may enable a transaction use case for a limited time, a limited amount, a limited geography, and a limited set of transaction requestors or similar limits that the transaction instrument issuer (12) may allow.

In one embodiment, the server (7) is co-located or even closely or fully integrated with the transaction management system (6). In another embodiment it communicates remotely to the transaction management system (6). The server (7) may be implemented as one or more physical or virtual instances and either used exclusively by or shared amongst two or more transaction instrument issuers. It may be operated by the transaction instrument issuer or by a third party or the functionality thereof offered on a software-as-a-service basis.

A device may also communicate to multiple servers operated by the same or different parties. To identify the correct server to communicate with, there is also provided for a directory server (11) or service that can be queried from the device (9) to identify the correct server (7) to send messages to in order to manage the transaction use case state relating to a specific transaction instrument (2).

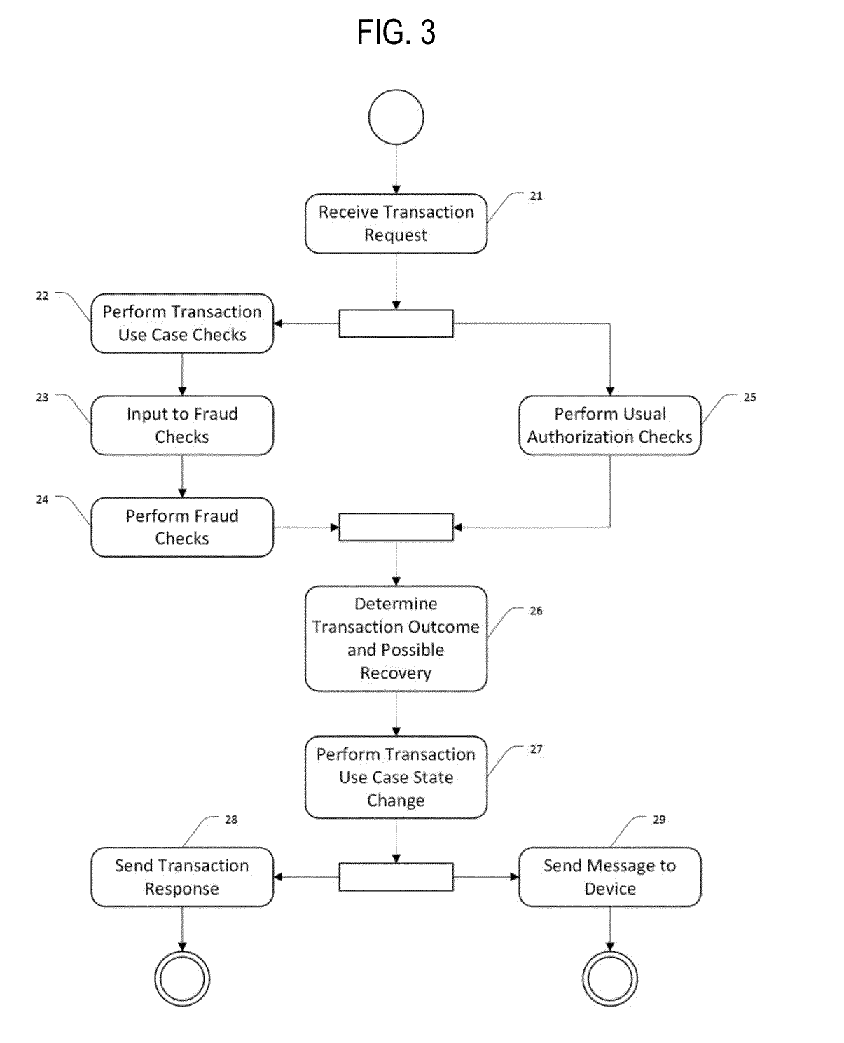

A specific example of a transaction flow is provided in FIG. 3. In this instance a transaction request is received (21) by the server. It performs the transaction use case checks (22), followed by transferring (23) the transaction request for fraud checks (24). In parallel with this authorization checks are conducted (25). The outcome of these parallel checks (22-24, and 25) are used to determine the transaction outcome and possible recovery if the outcome is that the transaction is declined (26). This may be followed by optional modification of transaction use case state (27) and messages to the transaction requester in the form of a transaction response (28) and a message to the device (29).

Recovery from declined transactions would then take the form of transaction use case state update (18) as per FIG. 2, followed by a reattempted transaction as per FIG. 3.

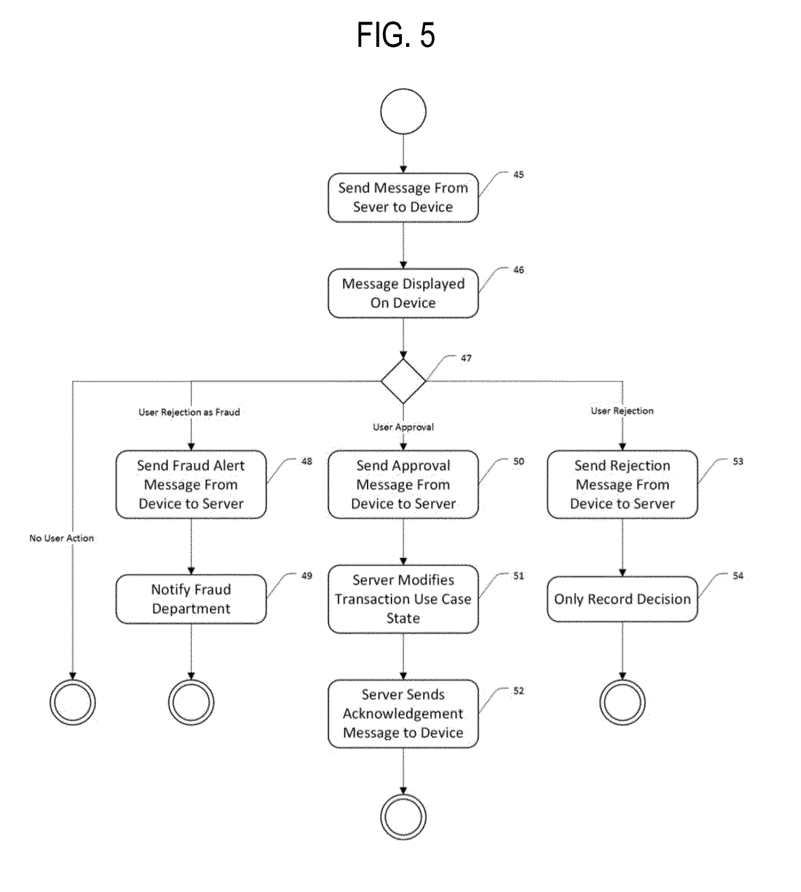

In another embodiment recovery from declined transactions would take the form of transaction use case approval (50) and state modification (51) as per FIG. 5, followed by a reattempted transaction as per FIG. 3.

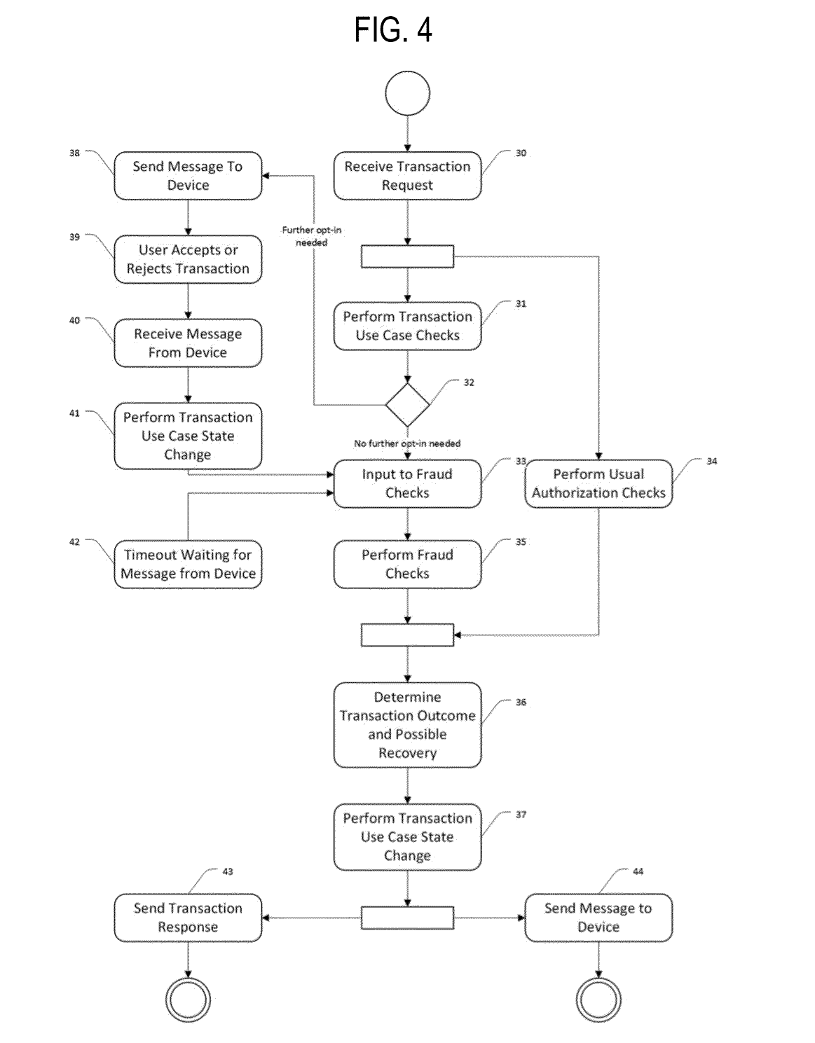

A further example is provided in FIG. 4, which relates to in-line confirmation requested from the device user. In this instance a transaction request is received (30) by the server. It performs the transaction use case checks (31). As an outcome of this, if the stored use case state does not allow for the transaction to be approved, an opt-in message is sent to the device (38). This prompts the device user to accept or reject the transaction (39). The device user transmits a message (40) back to the server, following which the server changes the transaction use case state (41) accordingly.

From here the transaction request is subjected (33) to fraud checks (35). If the device does not respond within a specified time period a timeout is noted for waiting for the message from the device (42). This is also input to the fraud checks (33).

In parallel with the transaction use case checks (31) the normal authorization checks are also conducted (34). The results of this and the outcome of the fraud checks (35) are used to determine the outcome of the transaction, and possible recovery if the outcome is that the transaction is declined (36). This may be followed by optional modification of the transaction use case state (37) and messages to the transaction requester in the form of a transaction response (43) and a message to the device (44).

Recovery from declined transactions would then take the form of transaction use case state update (18) as per FIG. 2, followed by a reattempted transaction as per FIG. 4.

In another embodiment recovery from declined transactions would take the form of transaction use case approval (50) and state modification (51) as per FIG. 5, followed by a reattempted transaction as per FIG. 4.

The purpose of the recovery message is to enable a transaction that has been declined to be processed successfully with intervention of the device user. This message will thus provide transactional information and indicate to the user which transaction use case state prevented the transaction from being completed, as a useful guide to the user on the change that is required to allow the transaction to be completed. This will allow the transaction to be completed if it is submitted again.

In this respect, as shown in FIG. 5, a message may thus be sent from the server to the device (45), to be displayed on the device (46). The user interacts (47) with his device in response to this displayed message (46). This may result in four possible outcomes, a first of which is no action from the user which leads to no change.

A second option is that the user may reject the requested recovery as a fraud, by way of a fraud alert being sent from the device to the server (48). This results in fraud notification being sent by the server to the relevant fraud department (49) that may open a fraud case or pursue some form of investigation. In this instance the transaction is not recovered since the device user confirmed it was a fraudulent transaction.

A third option is that the user may approve the requested recovery by sending an approval message from the device to the server (50). In response to this the server will modify the transaction use case state (51) to allow the transaction to be completed. The server then sends an acknowledgement message (52) to the device confirming the modification to the transaction use case state. This will allow the transaction to be completed if it is submitted again.

A fourth option is that the user may send a rejection message (53) from his device to the server. In this instance the transaction use case state remains unchanged and the decision of the user is merely recorded (54).

In this way it is possible to recover transactions which would otherwise be lost to the transaction instrument issuer. If the cause of a decline may have been due to fraud checks, then upon reattempt the input to the fraud checks including the modified transaction use case state may allow for the transaction to be approved.

It will be appreciated that the example embodiments and scenarios presented above are in no way intended to limit the scope of the invention. It is possible to modify aspects thereof without departing from the essence of the example embodiments. For example, items that are illustrated as happening in parallel may indeed happen in series instead. In addition, it is possible to construct combinations thereof to provide specific tailored solutions for customers.

I claim:

1. A method of processing a transaction associated with a transaction instrument, comprising:
providing a server with an associated processor and associated storage, a transaction use case interface configured to allow communication between the server and a device associated to a transaction instrument with at least one associated transaction use case, a transaction request interface configured to allow communication between the server and a transaction requestor via a transaction use case, and communication means between the server and a transaction management system, and storing on the server a channel state for each transaction use case associated with the transaction instrument,
receiving, at the server via the transaction use case interface, an update message from the device, the update message including data configured to be interpreted by the server to assign a transaction use case associated with the transaction instrument with either an allowed or a disallowed state,
the server identifying, with or without authentication, either the device user or the device or both and the associated transaction instrument,
the server updating the stored transaction use case state associated with the transaction instrument on the server,
receiving, at the server via the transaction request interface, a transaction request against the transaction instrument from a transaction requestor,
the server classifying the transaction use case used in the transaction request to determine a classified transaction use case associated with respect to the transaction instrument, by evaluating the fields in the transaction request,
the server retrieving the stored state of the classified transaction use case,
the server determining whether the stored state of the classified transaction use case is in the allowed or disallowed state, and
the server transmitting a message to the transaction management system containing data confirming either the state of the classified transaction use case or providing a general response of allowed or disallowed or both.

2. The method of claim 1, further comprising the server transmitting a decline message via the transaction request interface to the transaction requestor including data configured to be interpreted by the transaction requestor confirming that the stored state of the classified transaction use case is set as disallowed, and further preferably the server transmitting an approval message via the transaction request interface to the transaction requestor including data configured to be interpreted by the transaction requestor confirming that the stored state of the classified transaction use case is set as allowed.

3. The method of claim 1, further comprising the server transmitting a message via the transaction request interface to the transaction requestor including data configured to be interpreted by the transaction requestor indicating that the transaction request is approved or declined, based on whether the stored state of the classified transaction use case is set as allowed or disallowed.

4. The method of claim 1, further comprising the server classifying transaction use cases associated with a transaction request associated with a transaction instrument by evaluating a series of transaction fields extracted from the transaction request message, applying optional data sanitization, transformation and logic processing to a combination of such values within thresholds defined by configurable parameters associated to the server or the transaction instrument or the device or the device user or data sourced from an external system such as but not limited to a fraud scoring system or a geo-location system.

5. The method of claim 1, further comprising the server performing additional checks before or after classifying transaction use cases by evaluating transaction fields extracted from the transaction request message within thresholds defined by configurable parameters associated to the server or the transaction instrument or the device or the device user or data sourced from an external system, and optionally for the outcome of these checks to result in the transaction request being approved or declined, regardless of the allowed or disallowed state of the classified transaction use case.

6. The method of claim 1, further comprising the server receiving, via the transaction use case interface from the device, a query message including data configured to be interpreted by the server to determine confirming a stored transaction use case state associated with the transaction instrument and to transmit to the device a message containing data configured to be interpreted by the device confirming such stored transaction use case state.

7. The method of claim 6, wherein the state of a transaction use case stored in the server includes any one of allowed, limited by time, number for transactions, location, currency, value, merchant, type of merchant or other attribute, and preferably for the update message or the query message to relate to any such state.

8. The method of claim 1, wherein the server automatically changes a transaction use case state to allowed or disallowed upon the occurrence of any one or more of a number of events, including but not limited to, a transaction occurrence, the expiry of predeterminable period of time, or after a predeterminable period of inactivity.

9. The method of claim 1, wherein the server is configured to automatically modify configurable parameters associated with a transaction instrument upon the occurrence of any one or more of a number of events including, but not limited to, a transaction occurrence, the expiry of predeterminable period of time, or after a predeterminable period of inactivity.

10. The method of claim 1, further comprising the server transmitting, via the transaction request interface to a transaction management system associated with the transaction instrument, an approval message in the event that the stored state of the classified transaction use case is set as allowed.

11. The method of claim 1, wherein the server stores data of a plurality of transaction instruments, and further additionally stores data of multiple transaction instruments from one or more transaction instrument issuers in association with a single device.

12. The method of claim 1, wherein the server stores data associating more than one device with a single transaction instrument.

13. The method of claim 1, further comprising the server managing a subset of transaction use cases in respect of which each device or device user may alter the transaction use case states as associated to a transaction instrument.

14. The method of claim 1, further comprising the server managing an allowed range of values with which each device or device user may alter the configurable parameters as associated to a transaction instrument.

15. The method of claim 1, further comprising the server transmitting to an associated device messages stating the allowed or disallowed outcome of transactions.

16. The method of claim 15, further comprising the server transmitting to an associated device messages providing reasons for transactions being disallowed.

17. The method of claim 16, further comprising transmitting to an associated device messages providing a solution of submitting a transaction again, such as which transaction use case states to allow, if a transaction instrument is used by a transaction requestor without modifying the state of the transaction use case relating to the transaction instrument to allowing transactions or allowing transactions within configurable parameters.

18. The method of claim 1, further comprising the server transmitting, via the transaction use case interface to an associated device, a message including data configured to be interpreted by the associated device requesting confirmation of a transaction, and for the server to receive, via the transaction use case interface from such associated device, a message including data configured to be interpreted by the server confirming or denying the request for such transaction.

19. The method of claim 1, further comprising the server transmitting, via the transaction use case interface to an associated device, a message including data configured to be interpreted by the associated device requesting authentication of a transaction, and for the server to receive, via the transaction use case interface from such associated device, a message including data configured to be interpreted by the server authenticating such transaction.

20. The method of claim 1, further comprising the server being configured to manage an allowed range of values with which each device or device user may alter the configurable parameters as associated to a transaction instrument.

21. The method of claim 1, further comprising the server being configured to manage a number of devices to which messages will be transmitted based on the allowed/disallowed outcome of a transaction using an associated transaction instrument.

22. The method of claim 21, wherein the server is configured to manage a subset of messages that will be transmitted to each device.

23. The method of claim 1, further comprising the server including an associated directory server containing stored data of at least one transaction instrument issuer, and associated issuer identification number (IIN) data containing details of supported transaction instruments in relation to transaction instrument issuers.

24. The method of claim 23, further comprising the directory server receiving, from a device via the transaction use case interface, a directory lookup request message requesting retrieval of one or more server network addresses for the transaction instrument issuer of a specified transaction instrument, if the transaction instrument is identified on the directory server transmitting to the device a positive response message included one or more server addresses of the transaction instrument issuer associated with the transaction instrument, and still further if a transaction instrument is not identified on the directory server transmitting to the device a rejection message confirming that directory data for the transaction instrument in its lookup request message could not be located.

25. The method of claim 1, further comprising the server receiving, from a device via the transaction use case interface, an enrolment request message including data configured to be interpreted by the server requesting enrolment of the device with an associated transaction instrument on the server, the server comparing the received data relating to the transaction instrument to the data stored on the server, if the transaction instrument is identified on the server associated to the device or device user, transmitting to the device a positive enrolment response message including data configured to be interpreted by the device such as the description and design associated with the transaction instrument, and still further if a transaction instrument is not so identified transmitting to the device a rejection message including data configured to be interpreted by the device confirming that the transaction enrolment request failed.

26. The method of claim 25, further comprising the device storing information about the transaction instrument or network server addresses of the transaction instrument issuer.

27. The method of claim 25, further comprising the server including an associated membership service containing data of device users, optionally associated devices and optionally associated transaction instruments.

28. The method of claim 25, further comprising the server receiving a message from a device requesting a listing of devices and associated transaction instruments that can potentially be enrolled or are already enrolled for a device or device user and the server responding with a message including the requested listings of devices and associated transaction instruments.

29. The method of claim 1, further comprising the provision of a transaction instrument issuer interface which is configured to provide a transaction instrument issuer with the ability to define which transaction use cases are available for channel state modification in respect of a supported transaction instrument, and to query and modify the state of respective transaction use cases.

30. The method of claim 1, further comprising the server transmitting a message to the transaction requestor directly, or out of band from the transaction request, informing whether a transaction is allowed or disallowed.

31. The method of claim 1, further comprising authentication of the device or device user by the server to comprise the server receiving from the device a message including data configured to be interpreted by the server that provides the server with a device identifier, token or other credentials associated with the device or a transaction instrument associated with the device as stored on the server.

32. The method of claim 1, further comprising a provision of input to a risk assessment algorithm utilizing the transaction use case state stored on the server.

33. The method of claim 1, further comprising leveraging data from a central knowledge base to assist in transaction or transaction use case classification based on configurable parameters.

34. The method of claim 1, further comprising the server receiving, from a device via the transaction use case interface, a message including data configured to be interpreted by the server requesting the configurable parameters associated with a transaction instrument, retrieving the parameters from the server, sending a response message to the device including data configured to be interpreted by the device containing the requested configurable parameters.

35. The method of claim 1, further comprising the server receiving, from a device via the transaction use case interface, a message including data configured to be interpreted by the server requesting the modification of configurable parameters associated with a transaction instrument, updating the parameters on the server, sending a response message to the device including data configured to be interpreted by the device confirming the update.

36. The method of claim 1, wherein the transaction use case interface is accessible by means of a mobile phone using any one or more of communication channels including, without limitation:
WAP (Wireless Application Protocol),
USSD (Unstructured Supplementary Service Data),
SMS/Text (Short Message Service),
MMS (Multimedia Message Service),
STK (SIM Application Toolkit),
WIG (Wireless Internet Gateway), and
Smartphone application

37. The method of claim 1, wherein the transaction use case interface is accessible by means of a computing device via a web browser accessing a secure website such as Internet banking, alternatively using an IVR system.

38. The method of claim 1, further comprising authentication of a device user or assignee of a transaction instrument using authentication schemes including, without limitation:
PIN,
Password,
Certificates,
Biometrics,
Tokens, and
Challenges

39. A computerized system implementing the method as recited in claim 1, comprising a switching mechanism interposed between multiple transaction request interfaces and transaction management system interfaces.
